(19) United States
(12) Patent Application Publication
(10) Pub. No.: US 2007/0132278 A1
(43) Pub. Date: Jun. 14, 2007

(54) Vehicle panels and their method of construction

(76) Inventors: Paul Lester, Commerce Township, MI (US); Bryan Logan, Farmington Hills, MI (US); Jeremy A. Panasiewicz, Macomb Twp., MI (US); Gerard Olszewski, Temperance, MI (US); Patrick J. O'Mahony, West Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/301,210

(22) Filed: Dec. 12, 2005

(51) Int. Cl. B62D 29/04

(52) U.S. Cl. 296/191; 29/897.2

(57) ABSTRACT

A molded composite panel for a vehicle and a method of constructing a panel assembly. The individual panels have laminated layers of abutting dissimilar materials including a core of material and outer layers of fibrous material molded on opposite sides of the core. The outer layers are molded at least in part about a plurality of connection features such that the connection features are carried by at least one of the outer layers or the core. The connection features of one panel are accessible for operable attachment to connection features of an adjacent panel to form a panel assembly.

### FIELD OF THE INVENTION

The invention relates generally to vehicle panels, and more particularly to laminated vehicle panels and their method of construction.

### BACKGROUND OF THE INVENTION

Passenger vehicles have structural panels for supporting loads, such as cargo boxes in a pickup truck, and exterior panels defining the appearance of the vehicle. These panels are commonly formed from separate sheets of solid metallic or polymeric materials, such as steel, aluminum, plastic or fiberglass. The individual sheets are attached to one another using various mechanical fasteners and/or adhesives, which can ultimately prove costly.

Solid vehicle panels tend to be either relatively bulky, costly and heavy, or light and flimsy, typically resulting from an effort to reduce cost and weight. Accordingly, in constructing vehicle panels, there generally are tradeoffs between constructing strong, generally more durable panels verses lighter, generally less costly panels.

### SUMMARY OF THE INVENTION

In one presently preferred embodiment, a molded composite panel for a vehicle includes laminated layers of abutting dissimilar materials. The panel has a core and outer layers of fibrous material dissimilar to the core. The outer layers are molded on opposite sides of the core. A plurality of connection features are carried by at least one of the outer layers or the core. The connection features of one panel may be adapted for attachment to connection features of an adjacent panel.

A method of constructing a panel assembly for a vehicle is also provided. The panel assembly includes a two or more panels attached to one another. The construction includes providing a core of material having opposite sides; placing a plurality of connection features adjacent one of the sides of the core within a mold cavity of a mold tool, and molding layers of fibrous material over the sides of the core and at least partially about the connection features. During the molding process, the connection features preferably remain accessible such that connection features of one panel can be attached to connection features of an adjacent panel to construct a strong, relatively lightweight, and economical panel assembly.

### BRIEF DESCRIPTION OF THE DRAWINGS

These and other objects, features and advantages of the present invention will be apparent from the following detailed description of the presently preferred embodiments and best mode, appended claims and accompanying drawings in which:

FIG. 1 is a partial, cross-sectional, perspective view of a vehicle cargo box including one presently preferred embodiment of interconnected floor and side panels;

FIG. 2 is a perspective view of the floor panel of the cargo box;

FIG. 3 is a perspective view of one of the side panels of the cargo box;

FIG. 4 is a perspective view of a partially assembled cargo box;

FIG. 5 is a fragmentary cross-sectional view of the floor panel;

FIG. 6 is a fragmentary cross-sectional view of one of the side panels;

FIG. 7 is a fragmentary cross-sectional view taken generally along line 7-7 of FIG. 4 showing a protuberance molded within one of the side panels;

FIG. 8 is a fragmentary cross-sectional view taken generally along line 8-8 of FIG. 3 showing a receptacle molded within the side panels;

FIG. 9 is a fragmentary cross-sectional view of another embodiment of a panel; and

FIG. 10 is a fragmentary cross-sectional view of yet another embodiment of a panel.

### DETAILED DESCRIPTION OF PREFERRED EMBODIMENTS

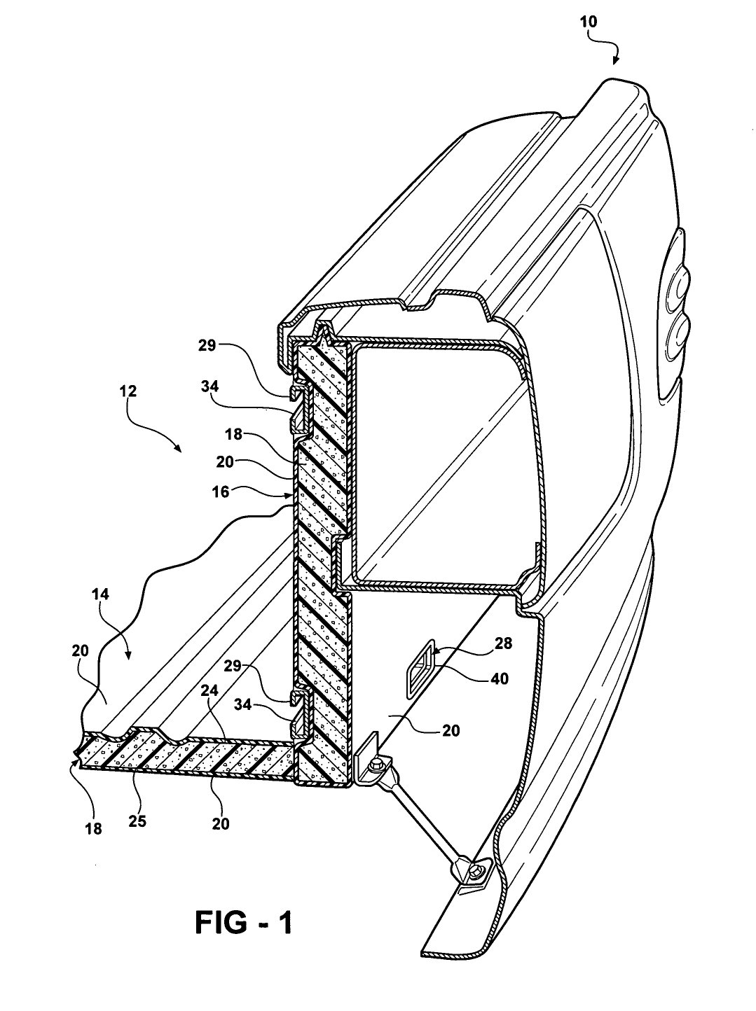

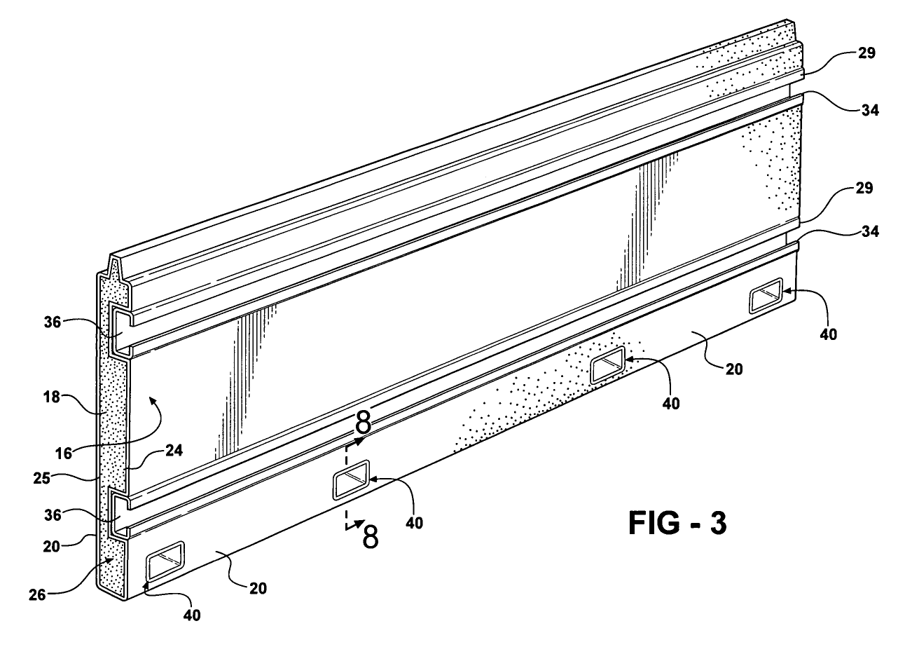

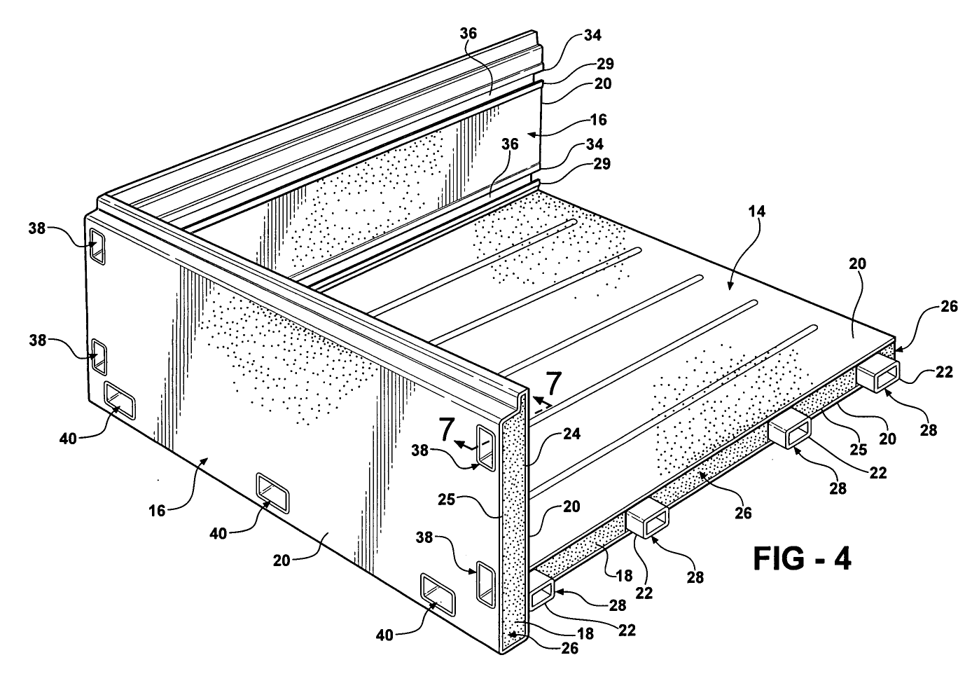

Referring in more detail to the drawings, FIGS. 1-4 illustrate a portion of a vehicle 10 having one presently preferred embodiment of a panel assembly, represented as a cargo box 12 of a pickup truck, by way of example and without limitation. The cargo box 12 has a load supporting floor panel 14 (FIGS. 1, 2 and 4) and upstanding side panels 16 (FIGS. 3 and 4) connected thereto. The floor and side panels 14, 16 are generally lightweight, high strength laminations with a core of material 18 sandwiched between outer layers 20 of fibrous polymeric material that preferably is dissimilar to the core material. A plurality of connection features are carried by and preferably integrated with the floor and side panels 14, 16. The floor and side panels 14, 16 are attached to one another via operable interconnection of the connection features 22 of adjacent panels to create a strong, rigid module assembly.

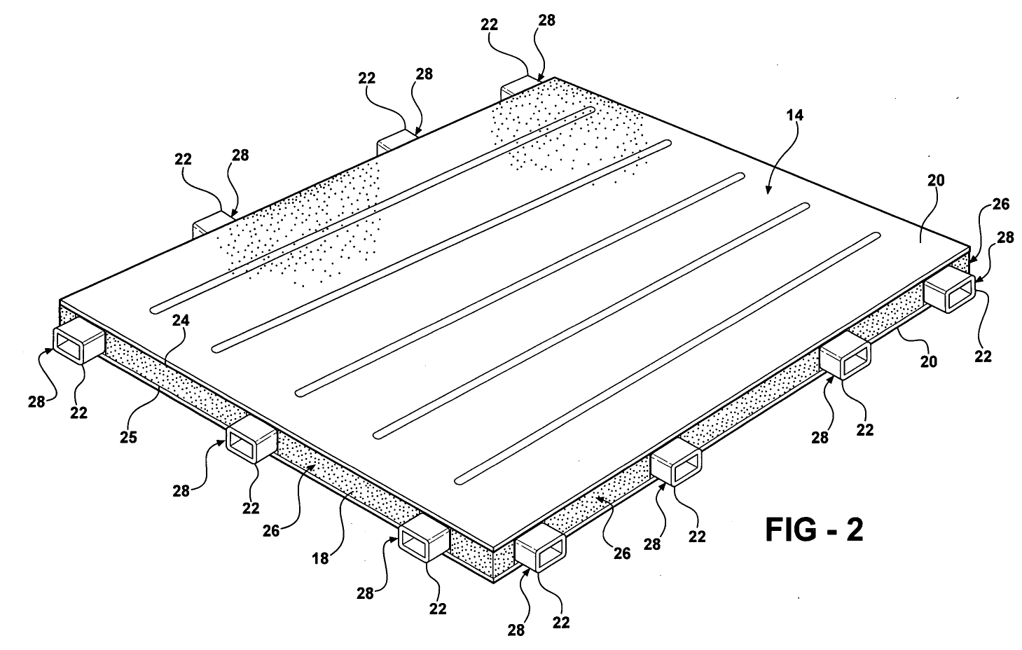

The core 18 includes opposite sides 24, 25 bounded by a peripheral edge 26 (FIGS. 2-4) and is constructed from a relatively lightweight material. Some examples of materials used to construct the core 18 include, without limitation, foams of polyurethane, polyester, polycarbonate, or honeycomb/expanded materials formed from cardboard, aluminum, polyester, polyurethane, polycarbonate, or other materials, such as balsa or Baypreg®. The core 18 generally functions as a spacer between the outer layers 20, and also adds stiffness to the panels 14, 16. The core 18 may also provide noise, vibration and harshness (NVH) dampening to the panels 14, 16. The core 18 can be incorporated between the outer layers 20 as a single piece of material, or as separate pieces of material.

The outer layers 20 are constructed at least in part from long fiber reinforced composite materials (LFCM's), such as those having individual fibers ranging between about 0.25″ to 3″ in length, for example. Some examples of the LFCM's used to form the outer layers 20 include, without limitation, fibers of glass, carbon, metal, and various types of polymeric materials, such as polyurethane. A polymeric binder, such as thermoset polyurethane, for example, reinforces the individual fibers. The LFCM's provide strength and durability to the panels 14, 16, thereby improving the wear, buckling and bending strength of the panels. In addition, the outer layers 20 can function as an adhesive to facilitate incorporating the connection features 22 in the panels 14, 16.

The connection features 22 are preferably constructed from metallic materials, such as steel or aluminum, though high strength polymeric or ceramic materials could also be used by way of examples, without limitation. In the embodiments shown, the connection features 22 in the floor panel 14 are extruded, rectangular tubular members, though they could take on any shape, and could be formed as solid members, in whole or in part, using any suitable manufacturing process. The connection features 22 provide rigidity and strength to the floor panel 14 and are preferably accessible adjacent at least one edge 26 and/or a side 24, 25 of the core 18 to facilitate connecting adjacent panels to one another. More preferably, connection features are exposed and accessible along each edge 26 of the floor panel 14.

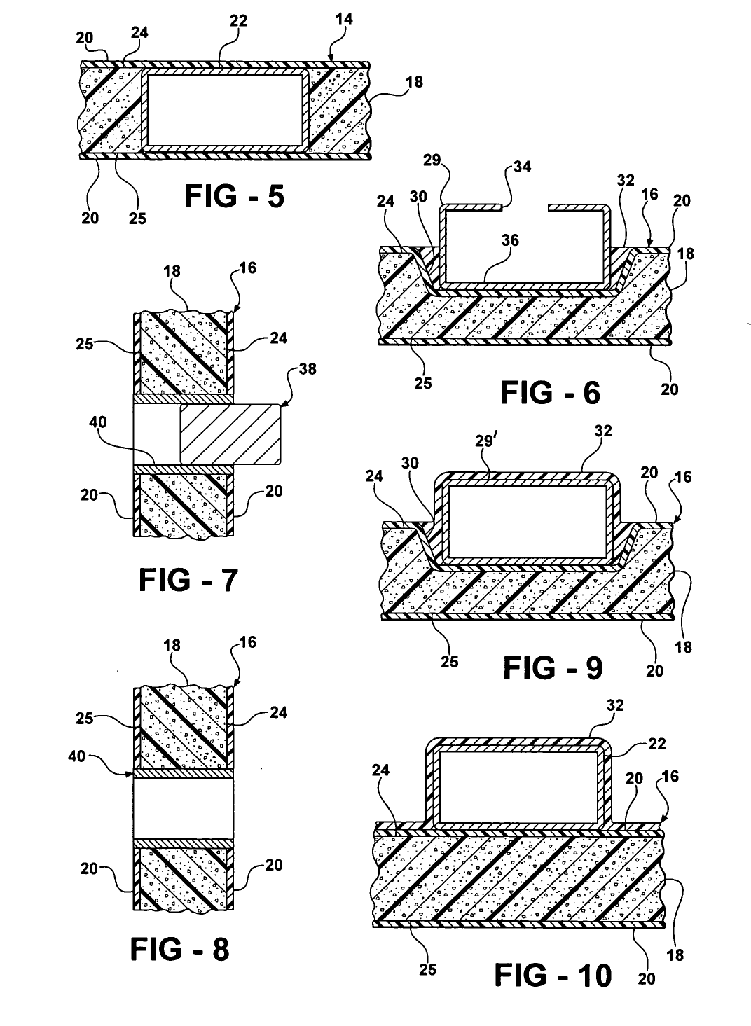

As shown in FIGS. 2, 4 and 5, the core 18 of the floor panel 14 is constructed from separate pieces of material sandwiched between the outer layers 20 of fibrous material. The separate pieces of core material are spaced from one another by spaced apart and generally parallel connection features 22. The connection features 22, by way of example and without limitation, are represented as extending into the edges 26 of the floor panel 14 in a generally parallel relation to the outer layers 20. However, at least some of the connection features/connection features 22 could extend completely through the core 18 between and generally parallel to the outer layers 20 of the floor panel 14, if desired. As such, some of the connection features 22 could be relatively short members extending into the sides 26, or they could be elongated members extending at least the full length or width of the panel 14 and preferably out of opposite sides 26 of the floor panel 14.

To construct the floor panel 14, a structural reaction injection molding process (SRIM) can be used, wherein connection features 22 are placed between core pieces 18 spaced from one another with opposed outer layers of the fibrous material laid over and under the core pieces 18 and connection features 22 to define a sandwiched subassembly. As shown in FIGS. 2 and 4, the connecting features 22 are preferably positioned to provide a protuberance such as an end 28 or other portion of the connection features 22 that extends outwardly from the edges 26 of the core pieces 18 and facilitates attachment of the floor panel 14 to the respective side panels 16. The ends 28 could also be provided by attaching separate pieces to the connection features 22, if desired. The subassembly is then placed in a mold cavity of a heated mold tool (not shown), wherein a polymeric resin, such as polyurethane, for example, is injected into the mold cavity and preferably allowed to flow about the subassembly. A vacuum is preferably applied within the mold cavity to facilitate penetration of the resin into the fibrous material. The resin is then allowed to cure within the mold cavity, thereby completing the formation of the outer layers 20 and panel 14. The panel 14 is then removed from the mold tool.

In another method of construction, rather than utilizing the SRIM process, a long fiber injection (LFI) process can be used. In the LFI process, the core pieces 18 and connection features 22 are placed directly into the mold cavity, whereupon individual fibers, such as chopped glass, for example, along with polymeric resin, such as polyurethane, for example, are injected over the surfaces of the core pieces 18 and connection features 22 within the heated mold cavity. A vacuum can be imparted within the mold cavity to facilitate uniform dispersion of the fibrous resin, if desired. The fibrous resin is then allowed to cure, and the floor panel 14 is removed from the mold cavity.

As shown in FIGS. 1, 3 and 6, one embodiment of the side panels 16 has the core 18 sandwiched between the outer layers 20 of fibrous material as a single piece of material with connection features 29 carried at least in part in recessed channels 30 of the core 18. To initiate the construction of the side panel 16, a subassembly is formed by placing the outer layers 20 in abutment with the opposite sides 24, 25 of the core 18. A layer of polymeric resin, such as thermoset polyurethane, for example, is then applied over the fibrous material, such as by spraying, for example. The subassembly is then transferred to a mold cavity and heated. The mold cavity can be formed having any desired shape, such that the channels 30 can be formed by compressing the core 18 within the mold cavity. Upon heating the resin and allowing it to cure, the shape of the mold cavity is generally retained by the respective outer layers 20 and the core 18.

Upon forming the subassembly, the connection features 29 can be carried at least partially in the preformed channels 30 and retained therein via an additional layer 32 of fibrous material. The connection features 29 can be molded in the channels 30 utilizing either the SRIM or LFI molding processes described above, for example. As shown in the embodiment in FIG. 6, the connection features 29 can extend partially above the outer layers 20, 32, have a longitudinal slot 34 and are generally rectangular and C-shaped in cross-section, although many other shapes and arrangements may be used. The slot 34 provides access to an interior space 36 that is preferably open at its ends to facilitate attaching other members (not shown) and adjacent side panels 16 to one another.

Some of the adjacent side panels 16 can be constructed with connection features in the form of protuberances 38 (FIGS. 4 and 7), disposed in receptacles 40 formed in the panels 16. Of course, the protuberances could be otherwise carried by the panels 16, such as by being molded therein. The protuberances preferably extend outwardly from one of the sides 20, and are preferably spaced for receipt within the open ends of the connection features 29. As such, the protuberances 38 of one side panel 16 can be disposed in the connection features 29 of an adjacent side panel 16, such as in a line-to-line or press fit, for example, to facilitate attaching the respective side panels 16 together. Upon disposing the protuberances 38 in the channels 36, an adhesive, fastener or weld joint, by way of examples and without limitation, could be used to facilitate their attachment to one another. The receptacles 40 are represented as having an outer tubular portion extending through the core 18 between, and generally perpendicularly to, the outer layers 20. The protuberance 38 can then be disposed in the tubular portion preferably with a tight fit or permanent connection within the tubular portion. However, the protuberances 38 could be molded into the respective side panels 16 using one of the SRIM or LFI methods described above. Openings can be preformed within the core 18, for example, as describe above for the recessed channels 30, with the protuberances 38 being molded or otherwise adhered in the openings thereafter.

In addition to the protuberances 38 and their respective receptacles, the side panels 16 preferably have additional receptacles 40 (FIGS. 3, 4 and 8) therein. Some of the receptacles 40 are preferably spaced for receipt of the connection features 22 of the floor panel 14, such as in a line-to-line or press fit, for example, to facilitate attaching the side panels 16 to the floor panel 14. The ends 28 of the connection features 22 may be disposed in the receptacles 40, and an adhesive, fastener or weld joint, by way of example and without limitations, could be used to facilitate their attachment to one another. The receptacles 40, by way of example and without limitation, extend through the core 18 between and generally perpendicularly to the outer layers 20.

As shown in FIG. 9, another panel construction is shown which is generally similar to that described above for FIG. 6, however the slot 34 is omitted from the connection features 29′ and the outer layer 32 is molded over the connection features 29′. As such, the connection features 29′ is entirely received and carried between the outer layers 20, 32.

As shown in FIG. 10, another panel construction is shown, wherein connection features 22 abut, or are carried adjacent a generally flat side of the core 18 by the outer most layer 32 being molded completely over the connection features 22. This construction is similar to that shown in FIG. 9, except a channel 30 is not formed in the core 18.

While certain preferred embodiments have been shown and described, persons of ordinary skill in this art will readily recognize that the preceding description has been set forth in terms of description rather than limitation, and that various modifications and substitutions can be made without departing from the spirit and scope of the invention. For example, it should be recognized that any number of connection features, including without limitation at least tubes, rods, bars, supports, protuberances, protrusions and receptacles, can be incorporated within specific panel constructions utilizing the molding processes described above. As such, vehicle panels can be constructed within the scope of the invention for a multitude of uses, with the cargo box embodiment discussed above being exemplary of only one embodiment. The invention is defined by the following claims.

What is claimed is:

1. A molded composite panel for a vehicle having laminated layers of abutting dissimilar materials, comprising:
a core;
outer layers of fibrous material dissimilar to said core and molded on opposite sides of said core; and
a plurality of connection features carried by at least one of said outer layers or said core and accessible from an exterior of the panel.

2. The panel of claim 1 wherein said connection features are tubular.

3. The panel of claim 1 wherein said core has a plurality of separate pieces with a separate one of said connection features received between adjacent ones of said core pieces.

4. The panel of claim 1 wherein said core is a continuous piece of material with opposite sides and said connection features are carried adjacent one of said sides.

5. The panel of claim 4 wherein said core has a recessed channel in one of said sides and said connection features are received at least in part in said channel.

6. The panel of claim 1 wherein said core has a peripheral free edge with at least one of said connection features being accessible adjacent said free edge to facilitate attachment of one panel to another panel.

7. The panel of claim 6 wherein at least one connection feature extends outwardly from said free edge generally parallel to said outer layers for receipt in a separate one of said connection features in an adjacent panel.

8. The panel of claim 1 further comprising another layer of fibrous material, at least one of the connection features being received between said another layer and the core.

9. The panel of claim 1 wherein said core has opposite sides with at least one connection feature extending generally perpendicularly to said sides and being accessible to facilitate attachment of one structural panel to another structural panel.

10. The panel of claim 9 wherein said at least one connection feature extends outwardly from at least one of said sides.

11. A panel assembly for a vehicle including a plurality of separate panels attached to one another, said panels comprising:
a core having opposite sides bounded by a peripheral free edge;
outer layers of fibrous material dissimilar to said core material molded on opposite sides of said core; and
a plurality of connection features carried by at least one of said outer layers or said core, at least one of said connection features on one panel being accessible for operable attachment to another connection feature of an adjacent panel.

12. The panel assembly of claim 11 wherein said at least one of said connection features of said one panel includes a protuberance extending outwardly from one of said sides, said adjacent panel having a connection feature including a receptacle for receipt of said protuberance.

13. The panel assembly of claim 11 wherein said core has a recessed channel in at least one of said sides, said at least one of said connection features being received at least in part in said channel.

14. The panel assembly of claim 11 further comprising another layer of fibrous material, at least one of the connection features being received between said another layer and the core.

15. A method of constructing a panel assembly for a vehicle including two or more panels attached to one another, the method comprising the steps of:
providing a core of material having opposite sides;
placing a plurality of connection features adjacent to the core in a mold cavity;
molding layers of fibrous material within a mold tool over the sides of the core and at least in part over the connection features to form one of the panels, the connection features having accessible ends; and
attaching the connection features of one panel to the connection features of an adjacent panel.

16. The method of claim 15 including attaching fibrous material to the opposite sides of the core prior to molding the layer of fibrous material over the connection features.

17. The method of claim 16 including forming recessed channels in the core while attaching the fibrous material to the opposite sides with the recessed channels being sized for at least partial receipt of the connection features.

18. The method of claim 15 including imparting a vacuum within the mold tool while, molding the layer of fibrous material over the connection features.
